(19) United States
(12) Patent Application Publication
(10) Pub. No.: US 2015/0248556 A1
(43) Pub. Date: Sep. 3, 2015

(54) Firmware Disassembly System

(71) Applicant: Government of the United States, as represented by the Secretary of the Air Force, Wright-Patterson AFB, OH (US)

(72) Inventors: Karl A. Sickendick, San Antonio, CA (US); Thomas E. Dube, Beavercreek, OH (US); Jonathan W. Butts, Dayton, OH (US); Barry E. Mullins, Beavercreek, OH (US)

(21) Appl. No.: 14/634,032

(22) Filed: Feb. 27, 2015

Related U.S. Application Data
(60) Provisional application No. 61/945,859, filed on Feb. 28, 2014.

(51) Int. Cl. G06F 21/56

(52) U.S. Cl. CPC G06F 21/563; G06F 2221/033

(57) ABSTRACT

Embodiments of the invention provide a method for disassembling firmware. A binary firmware image is received. If portions of the image are compressed, those portions are uncompressed. The binary firmware image is divided using a sliding window into a plurality of segments. Segments of the plurality of segments are classified as file types. Code file types are identified among the classified segments of the plurality of segments. Code architectures of the identified code file types of the classified plurality of segments are then classified. At least the classified code file types of the binary firmware image are disassembled based on the classified code architecture. The disassembled binary firmware image is evaluated for malware.

### CROSS-REFERENCE TO RELATED APPLICATIONS

This application claims the benefit of and priority to U.S. Provisional Application Ser. No. 61/945,859, entitled “Process for Firmware Reverse Engineering,” filed on Feb. 28, 2014, the entirety of which is incorporated by reference herein.

### RIGHTS OF THE GOVERNMENT

The invention described herein may be manufactured and used by or for the Government of the United States for all governmental purposes without the payment of any royalty.

### BACKGROUND OF THE INVENTION

1. Field of the Invention

The present invention generally relates to malware and, more particularly, identifying maliciously modified firmware.

2. Description of the Related Art

Supervisory Control and Data Acquisition (SCADA) systems, and more generally Industrial Control System (ICS) networks, control and monitor a diverse set of modern industrial processes. Services including gas and electricity distribution, water and wastewater control, telecommunications, and food processing rely on these systems to provide a modern level of performance. These processes are too complex to monitor and control economically without automation techniques. SCADA and ICS systems make these processes feasible by gathering data from remote sites, then correlating and displaying that data at an operator terminal.

SCADA systems are a part of the United States critical infrastructure (CI) as Presidential Decision Directive (PDD)-63 defined in 1998. CI includes public and private “physical and cyber-based systems essential to the minimum operations of the economy and government.” The directive acknowledges that in the past these systems were separate and independent, but recent automation and interconnection introduced vulnerabilities.

Initially, SCADA systems worked independently and in isolation, in a configuration similar to server mainframes. These characteristics defined the monolithic phase of SCADA architecture because one central unit, the SCADA Master, provided all computing and monitoring functionality. The lack of widespread networks and networking standards required every manufacturer to develop a proprietary system. Generally, the protocols did not tolerate other network traffic and were not easily extensible. Manufacturers designed and installed each SCADA system uniquely. The proprietary nature of the system software, networking, and even the connectors, required the manufacturer to perform most system modifications.

Monolithic systems provided fault tolerance through SCADA Master redundancy. A secondary system duplicated all functions of the primary, and monitored the primary's operation. When the secondary detected a fault it took over all operations. In general, the secondary greatly increased system cost but performed little work.

In the late 1980's personal computers became more affordable, and local area network (LAN) protocols became more standardized. These changes enabled SCADA architectures that distributed operator functionality and processing across multiple systems. Individual computers acted as human-machine interface (HMI) stations, as historian computers, and in many other roles.

While manufacturers used standard LAN technologies to connect operator stations, these networks had limited range. Many industrial processes still required communications between geographically scattered equipment. Manufacturers continued to use proprietary protocols developed during the monolithic architecture phase, and their makeshift wide area networks (WANs) were effectively single-use.

Distributed architecture SCADA systems only contained vendor-provided equipment. Often, only the vendor could perform system maintenance and upgrades. The distributed architecture enabled more flexible and economical fault tolerance, however. Often, other system components could handle the operations of failed system components in addition to their own tasks. Thus, distributed architecture systems did not require full-time standby systems.

Finally, in the mid 1990's manufacturers began to use largely commercial off-the-shelf (COTS) networking hardware and computer systems. They began to standardize protocols for end-devices like programmable logic controllers (PLC) and Remote Terminal Units (RTU), which enabled protocol transport over standard WAN networks. Standard protocols enabled companies to make in-house modifications to their SCADA networks, and to lower costs by leveraging their existing network infrastructure.

The networked SCADA architecture gave organizations greater flexibility in their operations. Connection with the business network for performance tracking and billing purposes became simple. Networked architectures also enabled off-site backup and fault-tolerance, enabling systems with the ability to survive disasters affecting entire geographical regions.

For all the benefits, the networked generation created new issues regarding system security and reliability. Unexpected interaction between SCADA and business systems caused reliability issues. Manufacturers' use of standard network protocols lowered the bar to system exploitation, and integrating CI and business network infrastructure expanded the potential attack surface-area.

Contemporary SCADA networks have a hierarchical structure, as illustrated in FIG. 1. Sensors and actuators 10 comprise the lowest level, and a sensor network connects them to PLCs and RTUs 12. Sensor network connections are generally short, and analog. PLCs and RTUs 12 consolidate control over the sensors and actuators, and then SCADA master units 14 control the PLCs and RTUs via a field network 16. Field networks 16 consist of longer-distance links than the sensor network. Contemporary field networks consist of Ethernet, serial cable, microwave radio, telephone, and many other connections. Control centers 18 provide centralized operator control over the system, and include terminals such as HMIs and data historians. Respectively, these enable operator control over a physical process, and long term system state storage.

Contemporary control centers consist of commercial off-the-shelf (COTS) computer and networking hardware, running COTS operating systems and custom control software. Increasingly, companies connect control centers 18 to their business networks 20. Generally they make this connection through a COTS firewall 22. Business network 20 connections enable companies to manage expenses and billing in real time, and to save costs by leveraging existing long-distance network connections. These connections also introduce vulnerabilities into the control system because many business networks have connections to external networks like the Internet.

The PLCs in these SCADA systems quietly manage dozens of systems modern societies rely on, and take for granted, every day. In turn, PLCs depend on firmware. In electronic systems and computing, firmware is the combination of persistent memory storing program code and data. Additional examples of devices containing firmware are embedded systems (such as traffic lights, consumer appliances, and digital watches), computers, computer peripherals, mobile phones, and digital cameras. The firmware contained in these devices provides a control program for the device.

Firmware is generally held in non-volatile memory devices such as ROM, EPROM, or other flash memory type devices. Traditionally, changing or modifying the firmware of a device rarely or never occurs during its economic lifetime; some firmware memory devices are permanently installed and cannot be changed after manufacture. Common reasons for modifying firmware may include fixing bugs or adding features to a device. Firmware modification typically requires physically changing ROM type integrated circuits or reprogramming flash memory type devices using special procedures. Firmware such as the ROM BIOS of a personal computer may contain only elementary basic functions of the device and generally only provides services to higher-level software. Firmware such as a program of an embedded system may also be the only program that will run on the system and provide all of its functions.

The networked generation of Industrial Control System (ICS) hardware enables operators to make economic decisions, which also may compromise system security. Attacking ICSs once required a sophisticated, well-financed attacker. However, high-profile attacks have shown that this assumption is no longer true. More sophisticated attacks like the Stuxnet malware now target PLCs specifically, but have not yet attacked or modified PLC firmware, though these attacks are likely coming. Open-source firmware projects for wireless routers and music players, and published modifications of other firmware, suggest that even unsophisticated attackers will be able to perpetrate PLC firmware attacks.

Firmware is a black box to the user, and a proprietary, undocumented, binary blob to the researcher. Header format is arbitrary and varies between manufacturer and model. Devices may also reorder sections and load code segments with arbitrary offsets. This causes firmware images retrieved with chip debugging tools to differ from pristine firmware images retrieved from manufacturer websites. Fortunately, manufacturers do not seem to purposely obfuscate firmware. However, the reverse engineering process still requires detailed analysis even before disassembling code segments, making the reverse engineering process tedious.

Until recently, little need existed to quickly reverse engineer PLC firmware. Forensics teams have not required the capability, and researchers have had successes discovering security vulnerabilities with externally-applied techniques like fuzz testing. Consequently, few analyses of PLC firmware exist, academic or otherwise. But, this requirement is changing with the proliferation of Internet connectivity for attackers and critical infrastructure alike.

Accordingly, there is a need in the art for an automated method to quickly disassemble firmware for malware analysis.

### SUMMARY OF THE INVENTION

Embodiments of the invention address the need in the art by providing an apparatus and method for disassembling firmware. A binary firmware image is received from a PLC or RTU. If the image contains compressed data, the binary firmware image is uncompressed before proceeding. The uncompressed binary firmware image is divided using a sliding window into a plurality of segments. Segments of the plurality of segments are classified as file types. Code file types are identified among the classified segments of the plurality of segments. Code architectures of the identified code file types of the classified plurality of segments are then classified. Finally, at least the code file types of the binary firmware image are disassembled based on the classified code architecture. Further, in some embodiments, the disassembled binary firmware image is evaluated for malware.

Some embodiments of the invention set a size of the sliding window such that it divides the binary firmware image into a configurable number of segments. Some of these embodiments set a step size for the sliding window equal to the size of the sliding window.

Some embodiments of the invention identify code file types and classifying code architectures utilizing boosted and unboosted decision trees, and support vector machines. In some embodiments, classifiers utilized for identifying code file types and classifying code architectures build and utilize models to determine which model best matches the segmenting being identified or classified.

Some embodiments disassemble identified code file types of the binary firmware image at all likely offsets for the classified architecture of the identified code file type. In some of these embodiments, the likely offsets consist of zero bytes, one byte, two bytes, or three bytes.

Additional objects, advantages, and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the invention.

FIG. 1 is an exemplary SCADA network diagram;

FIG. 2 is a diagram of contents of an exemplary firmware;

FIG. 3 is a block diagram of a firmware disassembly system consistent with embodiments of the invention;

FIG. 4 is a graph illustrating file segmenter performance;

FIG. 5 contains a table showing performance vs. parameter value for sliding window algorithms;

FIG. 6 contains a table showing performance vs. parameter value for entropy algorithms;

FIG. 7 contains a table showing a set of training characteristics;

FIG. 8 is a block diagram of the firmware disassembly system in FIG. 3 illustrating system boundaries, inputs, and outputs;

FIG. 9 contains a table showing an overall accuracy summary and 95% confidence interval for a machine learning pipeline;

FIG. 10 contains a table showing producer accuracy summary by file type and 95% confidence interval;

FIG. 11 contains a table showing a set of test characteristics; and

FIG. 12 is a diagrammatic illustration of an exemplary hardware and software environment suitable for performing firmware disassembly consistent with embodiments of the invention.

It should be understood that the appended drawings are not necessarily to scale, presenting a somewhat simplified representation of various features illustrative of the basic principles of the invention. The specific design features of the sequence of operations as disclosed herein, including, for example, specific dimensions, orientations, locations, and shapes of various illustrated components, will be determined in part by the particular intended application and use environment. Certain features of the illustrated embodiments have been enlarged or distorted relative to others to facilitate visualization and clear understanding. In particular, thin features may be thickened, for example, for clarity or illustration.

### DETAILED DESCRIPTION OF THE INVENTION

Firmware exists on the boundary of hardware and software. Firmware controls the start-up sequence of contemporary personal computers (PCs), enabling low-level user configuration and transfer to larger, more complex operating systems. Firmware eases startup by permitting modern operating systems access to a standard interface, abstracting out many differences in PC hardware. Contemporary PCs store firmware in electrically erasable programmable read-only memory (EEPROM) chips and store the main operating system on storage external to the system motherboard.

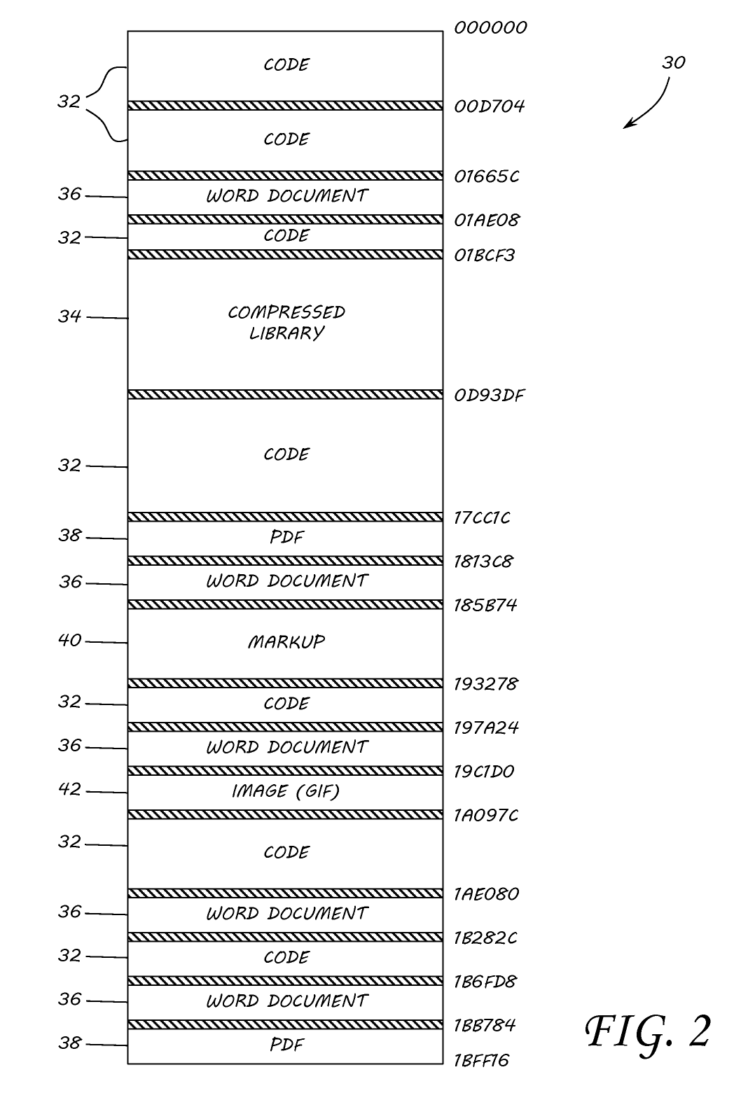

In contrast, firmware often provides all system software functionality for embedded devices such as in programmable logic controllers (PLCs). Due to space and durability requirements embedded devices often do not contain storage external to the motherboard, and can therefore only execute an operating system stored in ROM, EPROM, or flash memory. Little reason exists, then, for firmware to transfer control to any other entity, and manufacturers incorporate a full operating system and all software in the firmware. For example, an exemplary portion of flash memory 30 in FIG. 2 illustrates a potential firmware setup containing code segments 32, compressed libraries 34, and data, which may include application files such as Word documents 36, PDF files 38, Markup data 40 such as XML, and images 42 such as GIF or JPEG files, among other files.

Generally, PC operating systems and software provide simple update techniques, enabling users to patch unsecure software quickly once manufacturers release updates. Updates to firmware require more user effort. Many systems require that the hardware be rebooted into a maintenance mode or manipulate hardware switches. Performance or safety-critical devices may require disconnection from the rest of the system. Firmware's critical function also makes testing procedures more vital than for conventional software. These complications make firmware security vulnerabilities more valuable to attackers.

The Department of Homeland Security (DHS) defines five groups of cyber threats, depicted below in order of increasing consequence and decreasing threat frequency. Nuisance hackers comprise the overwhelming majority of cyber attacks and include groups such as hacktivists, individuals that use cyber action as a form of protest or to achieve political ends. Despite the group's lack of resources and the general low complexity of their attacks, nuisance hacker attacks occasionally cause significant economic consequence. Notoriety, mischief, or publicity for a cause frequently motivate nuisance hackers. Money motivates criminals and gangs, who have resources which enable attacks of greater complexity than nuisance hackers. The DHS list of cyber threats is:

1. Nuisance Hackers

2. Criminals and Gangs

3. Nation-States Motivated by Theft

4 Limited Resource Nation-States and Terrorists

5. Unlimited Resource Nation-States

Threat groups three through five possess significantly more resources. Each has the ability to seize control, through force, of corporations which produce cyber technology. Military concerns motivate each, and economic and diplomatic concerns motivate all but terrorists. Group three includes nation-states that steal private intellectual property and national secrets. This threat group's actors are unwilling to cause physical damage with their actions, though they possess that capability. The limited and unlimited resource groups are willing to cause physical damage. Money, time, or technical access may limit the limited resource actors. Unlimited resource actors attack with monetary resources, technical access, and speed that overwhelm any adversary.

Attacks on the older, distributed architecture, SCADA systems, require physical access and special network equipment. These requirements demand a moderate amount of attacker resources. Attacks demand long-term planning, and that reduces attack payoff.

Modern networked SCADA systems lower the bar to attacker entry. Their connections to the Internet, and use of common network protocols, enable nuisance hacker attacks. Search engines like SHODAN make searching for Internet-facing SCADA networks relatively simple. SHODAN and tools like Metasploit and THC-Hydra enable nuisance hacker SCADA human-machine interface (HMI) attacks.

System operators can recognize many simple cyber attacks by their immediate system effects, but the term advanced persistent threat (APT) describes a more insidious attacker. Long term reconnaissance and data exfiltration characterize the APT. These actions require more resources than nuisance hackers possess, and until recently required more resources than criminals possessed. The proliferation of network attack tools and knowledge enables organized criminals to act as APTs.

Insider threats and self-inflicted malfunction form a sixth threat category. Insiders are employees and business associates that intentionally cause damage to an organization. They work with an external actor, or alone, to sabotage the organization. Insiders do not require many resources because their position grants them access to critical systems. Separately, self-inflicted malfunction causes unintentional damage to an organization, and occurs due to operator error or equipment failure.

Vitek Boden attacked the Maroochy Shire Council sewage system in 2000 in the first well-known ICS attack. He stole equipment from Hunter Watertech, his former employer and the company which installed the SCADA system, then used the equipment to sabotage the system's operation. The system lacked cyber defenses, and its security relied on the obscurity of the system's radio communication frequencies and protocols.

Vitek disabled sewage pumps and sensor alarms, and disrupted remote station communications at several locations over a period of three months. Initially, operators attributed malfunction to installation error. A lack of cyber defense logs and tools, and Vitek's actions to hide his attacks, led system operators to that incorrect conclusion. Vitek's success was due to his theft of equipment and a lack of cyber defense, and as such his attack was of low complexity.

Attacker pr0f_srs broke into the water infrastructure for South Houston, Tex., in 2011. He claimed that the SCADA system used a three letter password, and that knowledge of the system's software, and guessing the password, allowed him control over the system. The attacker posted screenshots of the control system to Twitter and claimed that the attack was partly in response to public DHS statements. This attack was of low complexity, and the attacker acted as a hacktivist in this instance.

Stuxnet is a computer worm that targets particular ICS hardware configurations and sabotages their operation. Specifically, Stuxnet targets Siemens' SIMATIC PCS 7, an industrial automation system in which the operator terminals execute Microsoft WINDOWS®. It uses four exploits to propagate: a WINDOWS shortcut vulnerability, shared network folders, a WINDOWS remote procedure call (RPC) vulnerability, and a WINDOWS printer sharing vulnerability. Stuxnet uses several other WINDOWS vulnerabilities to increase its privileges.

Stuxnet modifies code on PLCs to vary the speed of motors. The modified motor speed sabotages the industrial process controlled by the motor. Some researchers count Stuxnet among the most complex threats they have analyzed. It exploits at least four previously-undisclosed bugs, and analysis shows that an organized team with delineated responsibilities likely built its components. Analysts believe that constructing the Stuxnet worm required resources beyond the capabilities of all but a few attackers. The complexity and consequences of Stuxnet suggest that the attacker belonged to threat groups four or five: limited resource nation-states and terrorists, or unlimited resource nation-states.

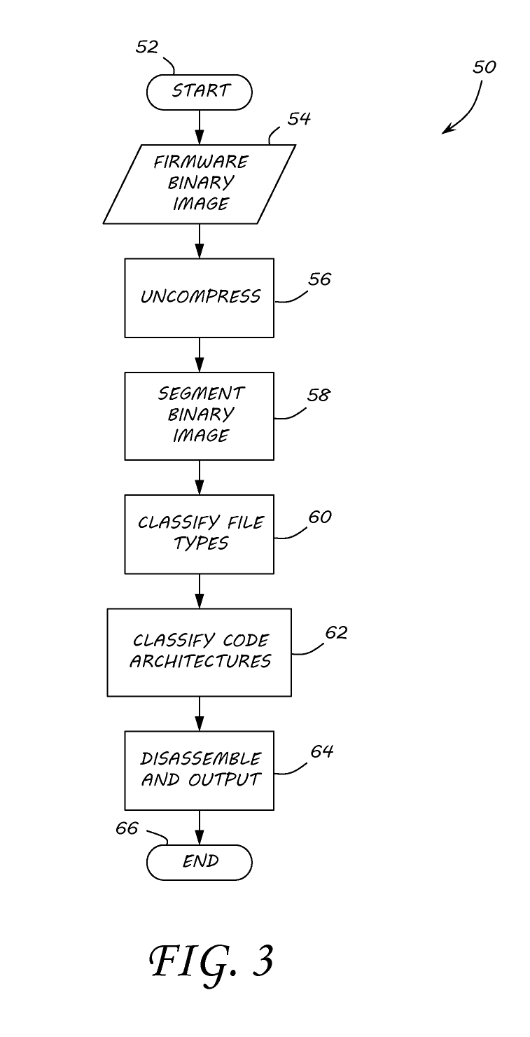

Embodiments of the invention assist in simplifying reverse engineering of firmware in devices such as PLCs, which can then be analyzed to recognize and identify threats. A reverse engineering process of the embodiments is illustrated in flowchart 50 in FIG. 3. The process begins at block 52. A firmware binary image is received as input to the process at block 54. Firmware often includes compressed segments, such as the exemplary compressed library 34 in FIG. 2, and embodiments of the invention find and uncompress those segments in block 56. Next, the firmware binary image is segmented in block 58. Some complex firmware may also include web-server functionality including documentation or status outputs and some embodiments of the invention may also identify likely data segments containing common file types.

Firmware images contain many component segments, including code and data segments. Separating data from code is an initial step in firmware disassembly. All contemporary file systems contain metadata that describes the actual file system. Minimally, the file system stores: a hierarchy of folders and files with names for each. A physical address on the hard disk where the file is located is also stored for each file. When this metadata is lost or damaged, the file(s) associated with the metadata cannot be accessed. File carving is a process of trying to recover files without this metadata. This is traditionally accomplished by analyzing raw data and identifying what it is (text, executable, png, mp3, etc.). This can be done using different methods, but the simplest is to look for headers. For instance, every JAVA® class file has as its first four bytes the hexidecimal value CA FE BA BE. Some files contain footers as well making it just as simple to identify the ending of the file.

Embodiments of the invention apply file carving algorithms to the segmenting and file type identification problem, and apply malware identification algorithms to the code architecture identification problem. The embodiments evaluate each algorithm's accuracy when applied to firmware binaries or code segments respectively. Each file carving algorithm classifies the file type of a segment (block 60) of the binary image during the segmenting in block 58. The file carving algorithms do not segment the file themselves, and require a separate segmentation algorithm.

Embodiments of the invention take advantage of work done with a segmentation algorithm by, Conti, et al., “Automated mapping of large binary objects using primitive fragment type classification,” which is hereby incorporated by reference herein. Conti et al. solve the problem of segmenting binary files with a sliding window. Conti's sliding window is 1024 bytes wide with a step size of 512 bytes, and matches properties of their statistical classifier. Embodiments of the invention consider file segmentation with a generalized version of the sliding window. A second file segmentation technique calculates an entropy value for each byte in a firmware based on a sliding window. This second technique uses a segmented-least-squares algorithm to minimize the number of firmware sections, and to minimize the squared error of each section's mean entropy.

Segmenting and classifying file type of binary firmware images are the main workload of the embodiments of the invention. Ideally, real firmware would form a test set for the embodiments. To evaluate the results, however, the test set must include metadata that describes the firmware contents. Unfortunately, few PLC firmwares exist which meet that requirement. Real firmware images vary widely in composition. Simple PLCs may only require a firmware with one code segment. More complex PLCs with Ethernet interfaces may provide Web and FTP servers, and require larger firmwares that include file systems and multiple code segments. Many PLCs are modular, and contain several processors with potentially different architectures.

In their work, Conti et al. classify 14,000 1 kB file fragments from 14 common file types using their k-NN algorithm. Their k-NN algorithm evaluates the distance between fragments with Euclidean and Manhattan distance over four file statistics: Shannon entropy using byte bigrams, byte value arithmetic mean, Chi Square Goodness of Fit of byte distribution to a random distribution, and Hamming weight. Conti et al. define Hamming weight as the proportion of “one” bits in a segment. Equations (1) and (2) give the Shannon entropy and Chi Square equations, respectively.

$$\begin{matrix}H ( x ) = - {\sum }_{i = 0}^{255} p ( {X}_{i} ) {log}_{1} 0 ( p ( {X}_{i} ) ) & ( 1 ) \\ {χ}^{2} = {\sum }_{i = 0}^{255} \frac{{( {o}_{i} - {e}_{i} )}^{2}}{{e}_{i}} & ( 2 )\end{matrix}$$

In Equation (1), p(Xᵢ) represents the probability that byte value i occurs within a file fragment. In Equation (2), oᵢ represents the frequency of byte i within a file fragment, and eᵢ represents the expected frequency of byte i within a uniform random distribution. Conti et al. calculate Chi Square Goodness of Fit using the χ² value and a Chi Square distribution with 255 degrees of freedom. They determine that, for their test cases, Euclidean distance classifies file fragments more accurately than Manhattan distance.

Conti et al. extract file fragments from the approximate middle of sample files to avoid file headers and footers. Their 14 file types consist of compressed data in several formats, encrypted data, random data, base64 or uuencoded data, Linux ELF and Windows PE executable data, bitmap data, and mixed text data. During classification, Conti et al. test values of k from 1 to 25, and settled on k=3 because larger values provided no significant return. The classifier was unable to distinguish several file types during 14-value classification, so Conti et al. clustered each file type by similarity, making the problem 6-value classification. They clustered the random, encrypted and compressed data together, clustered the executable formats, and placed the other file types in individual clusters. Their classifier achieved 82.5% accuracy for bitmaps, and better than 96% accuracy for the 5 other clusters.

To classify fragments using embodiments of the invention, statistical signatures of 14,000 fragments (1000 fragments of 14 commonly encountered primitive types) were created. The size of each fragment was 1024 bytes, and they were collected using two sources. Some were collected directly from files known to consist of a single type, such as a file containing solely random numbers. In the case of files with headers and/or footers and a core payload of a desired primitive type, fragments were extracted from the middle of the file or, if possible, using knowledge of a region's exact location. To understand the statistical characteristics of each type and to facilitate classification, four statistical tests were selected and these selected tests were used to develop statistical signatures for each fragment.

With the two file segmenting algorithms in mind, embodiments of the invention were analyzed for performance of four variations on those algorithms. The first general algorithm is a generic sliding window, but unlike Conti et al., the variation for this embodiment included a configurable window and step size. An Even Divisions algorithm utilized in an embodiment of the invention refers to a sliding window with window size such that it breaks a file into a configurable number of segments. Even Divisions uses a step size equal to the window size.

The second general algorithm used in embodiments of the invention chooses segments based upon regions of constant entropy. Specifically, a Segmented-Least-Squares algorithm uses segmented-least-squares to choose segments in order to minimize both mean-squared-error and segment count. Unfortunately, the segmented-least-squares dynamic programming algorithm is of O(n³) complexity. To achieve reasonable analysis run times, e.g., less than a day on firmwares greater than 500 kB, the Segmented-Least-Squares algorithm uses a Douglas-Peucker algorithm as an initial filter on the entropy values. The Douglas-Peucker algorithm reduces a set of points while maintaining the original shape. One embodiment also considered the performance of the Douglas-Peucker algorithm alone at reducing entropy values to a set of sections.

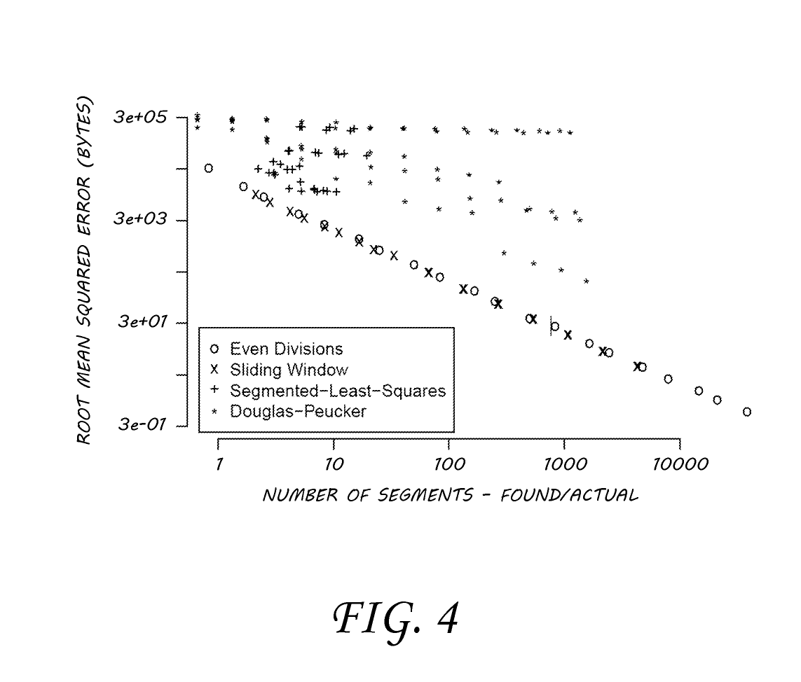

The file segmenter test set consists of a set of pseudo-firmwares containing a total of 120 segments, and comprising 8 MB. FIG. 4 illustrates a performance overview of the four file segmenting algorithms. The segment and code type classifiers require time to run, and the time to classify all segments increases approximately linearly with the number of segments. Therefore, an appropriate file segmenting algorithm must accurately find file segments without introducing too many segments. Thus, FIG. 4 compares file segmenter root mean square error (RMSE) and the ratio of segments yielded to actual.

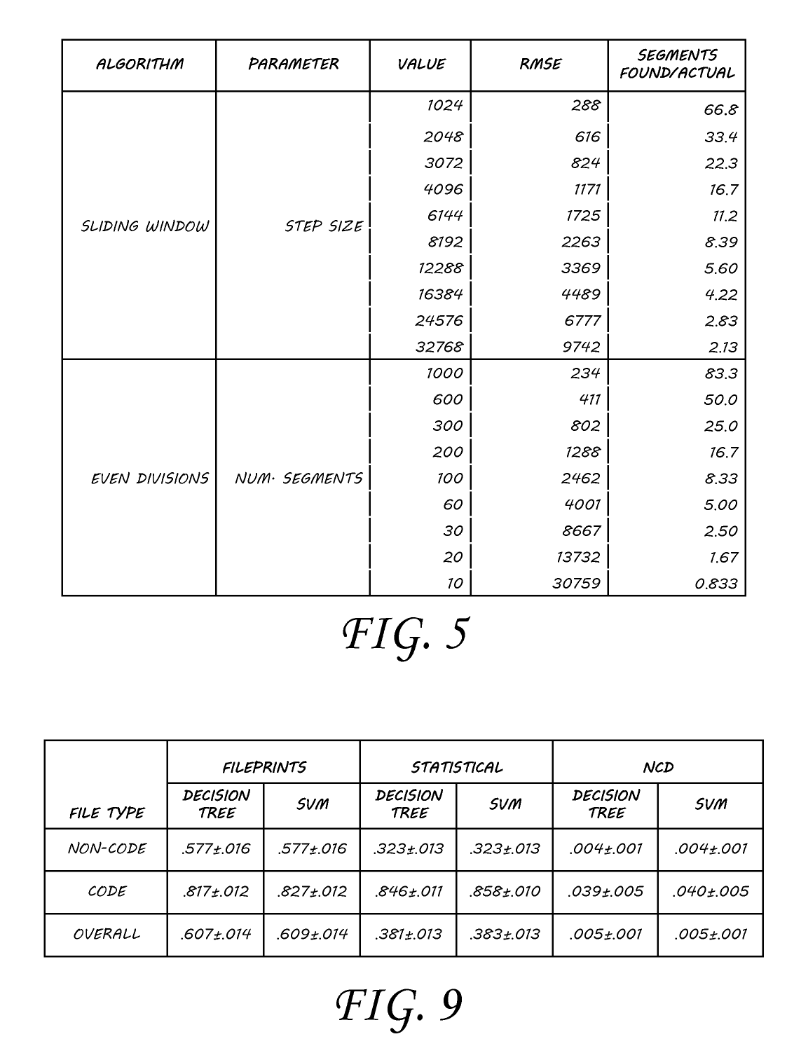

Both general sliding window algorithms perform similarly, and produce the best tradeoff between segment ratio and error. In no case did the entropy algorithms produce an error better than the general sliding window algorithms at a similar segment ratio. The table in FIG. 5 shows the relationship between algorithm parameters and error for both sliding window algorithms. The performance of Sliding Window depends only upon step size and not upon window size, due to the definition of error in this test. Thus, the table does not contain window size. In practice the window size must be at least as large as the step size, or the sliding window will skip bytes between windows.

The table in FIG. 5 only displays configurations which yield between 100 and 12,000 segments for the 120 segment input, as indicated by found-to-actual segment ratios between 0.833 and 100. Configurations with found-to-actual ratios less than 1 cannot provide enough information for the file type classifier to identify all component files, and must provide an analyst with incomplete results. Found-to-actual ratios greater than 100 caused excessive firmware analysis times and are therefore unreasonable in practice.

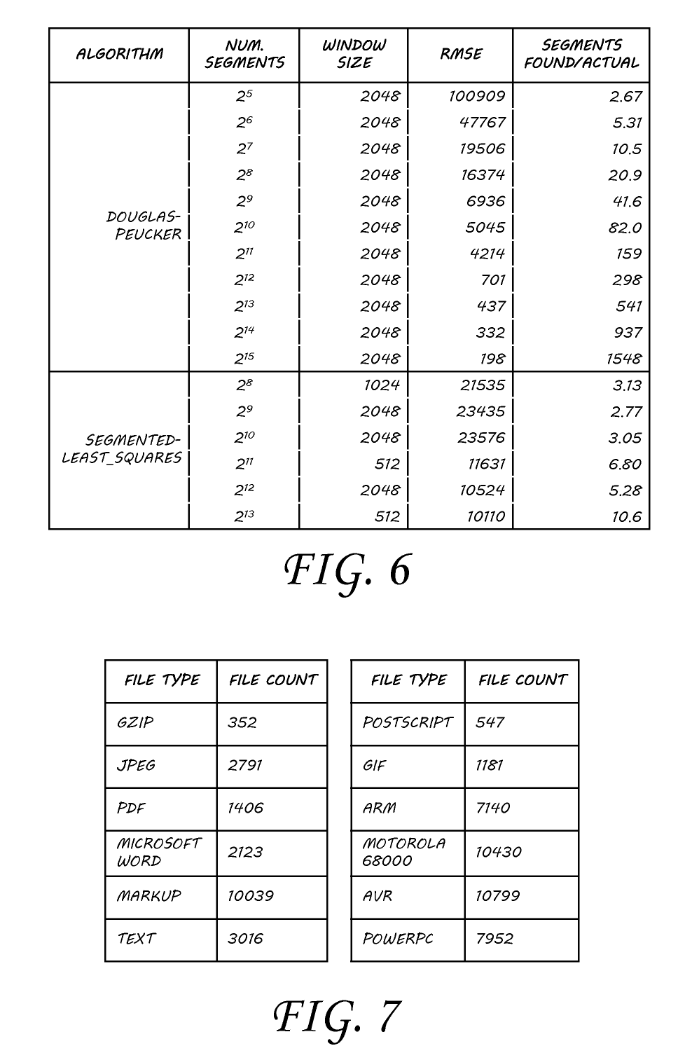

The table in FIG. 6 compares the performance of Douglas-Peucker and Segmented-Least-Squares. It contains results of the tests with the best root-mean-square error (RMSE) for each value of Num. Segments. Segmented-Least-Squares only has Num. Segments values up to 213 due to run time limitations. The algorithm's O(n³) nature causes larger values of the parameter to require longer and at times, unacceptable, firmware analysis times.

The Num. Segments parameter specifies an approximate number of points for the Douglas-Peucker algorithm to output, whether it's acting as a filter for Segmented-Least-Squares or on its own. For Douglas-Peucker an increase in this parameter value corresponds with an increase in the number of segments it yields. In general, this statement holds for Segmented-Least-Squares too, because an increase in the parameter gives the algorithm more points to consider, and therefore more potential segments. In the case of Num. Segments values 28 and 211, however, this statement does not hold. An interaction with the Window Size parameter causes Segmented-Least-Squares to yield more segments than with larger Num. Segments parameter values.

Both general sliding window algorithms execute quickly. They perform segmentation in less than one second for all cases in the table in FIG. 5. Indeed, they only need to determine the size of the test firmware to perform segmentation, which is a speedy task on modern computing architecture and operating systems. In contrast, Douglas-Peucker requires approximately 900 seconds to complete segmentation for the test set. Segmented-Least-Squares requires approximately 8000 seconds in the lowest error test cases, or 3000 in next-lowest error cases.

The remaining steps of the process will be described based on the embodiment utilizing the Even Divisions algorithm, though other embodiments may utilize any of the algorithms discussed above. Because large values of the parameter (or small input firmwares) may result in segments inappropriately small for file type and code classifiers, this embodiment will enforce a minimum segment size of 512 bytes. The embodiment also uses 100 for the Num. Segments parameter to provide a reasonable balance between run-time and accuracy for the available firmwares. Other embodiments, or other configurations of this embodiment may use other values for the minimum segment size and number of segments parameter.

Returning now to FIG. 3, after the binary image has been segmented in block 58, the segments are classified into file types in block 60. If these identified file types are determined to be executable code, the code architecture is also classified in block 62. Embodiments of the invention take advantage of work done on algorithms to identify file types by S. Axelsson, “Using Normalized Compression Distance for Classifying File Fragments,” Li et al., “Fileprints: identifying file types by n-gram analysis,” and Conti et al. above, the contents of which are hereby incorporated by reference herein.

One embodiment of the invention utilizes Axelsson's file type identification technique. Axelsson characterizes files with normalized compression distance (NCD), then associates the files with file types from a training set using k-nearest neighbor. In a second technique used in other embodiments, Li et al. perform n-gram analysis on their training set to characterize file types, then uses Mahalanobis distance to associate files with file types. The third file identification technique, used in still other embodiments, characterizes file segments with four statistical signatures. Conti et al. use k-nearest neighbor to associate members of their test set with file types. All three file identification algorithms perform classification for two or more classes.

More particularly, Axelsson uses normalized compression distance (NCD) and k-Nearest Neighbor (k-NN) to perform n-value file segment classification. NCD is an approximation of normalized information distance, which is a measure of data entropy. Axelsson defines NCD with Equation (3) below, where C(x) is the compressed length of x, and C(x, y) the compressed length of x and y concatenated. Axelsson chooses gzip as the compression algorithm, and investigates settings of k from 1 to 10. The algorithm calculates NCD for 512 byte test and training fragments, then assigns test segments the most common file type among the k lowest NCD values.

$$NCD ( x , y ) = \frac{C ( x , y ) - min ( C ( x ) , C ( y ) )}{max ( C ( x ) , C ( y ) )} \qquad ( 3 )$$

Axelsson's file corpus contains 17 file types including executable files, images, movies, and common document formats. Axelsson reports approximately 50% accuracy overall for the 17-value classification problem, but approximately 90% accuracy for several file types. Furthermore, Axelsson finds that, among the tested values, no k value performed better than the others. Axelsson suggests that future work should consider classifying fragments into more generic file type classes.

Li et al. describe the performance of a system they call Fileprints. The Fileprints system models file types with the mean and standard deviation of byte value frequency. Li et al. design Fileprints to handle byte value n-grams, but determine that 1-grams are sufficiently complex to accurately classify files. Additionally, a 1-gram file footprint (a fileprint) contains only 256 elements, whereas a 2-gram fileprint requires 256 times the storage space. Li et al. find the 1-gram fileprint performance sufficient, especially considering the low storage requirement advantages.

The Fileprints test corpus consists of five general file types: EXE (including DLL files), GIF, JPEG, DOC (including Word, PowerPoint and Excel files), and PDF. Li et al. consider three model types. Their single-centroid model combines each file type's training examples into one fileprint per type. A multi-centroid model consists of multiple models for each file type. K-means clustering builds K fileprints per type. The third model type uses individual training examples as fileprints. Therefore, if n training samples belong to file type t, Fileprints assigns n models to file type t.

With both the single and multi-centroid models Fileprints finds average byte value frequencies over all training examples, then calculates a Mahalanobis distance to training samples to determine the closest training model. Li et al. give Mahalanobis distance as Equation (4), where i is byte value. Values xᵢ and σᵢ of are the mean frequency and standard deviation, respectively, for i in the training examples. Then, yᵢ represents i's frequency in the test sample. Li et al. use a as a smoothing factor, which becomes necessary when the standard deviation is 0. Fileprints classifies a test sample as the type of the closest training example. No standard deviation values exist for Fileprints' third model type, so Li et al. cannot use Mahalanobis distance, and use Manhattan distance instead.

$$D ( x , y ) = {\sum }_{i = 0}^{n - 1} \frac{\vert {x}_{i} - {y}_{i} \vert}{{σ}_{i} + α} \qquad ( 4 )$$

Fileprints' accuracy on the five-way classification problem with the single-centroid model is 82%. With the multi-centroid model and individual-example models they find 89.5% and 93.8% accuracy, respectively. Li et al. find better performance when they truncate files. Truncation causes file header magic numbers to occupy a greater percentage of the total file. Li et al. truncate test and training files to include only the first 20 bytes, then apply Fileprints using the single-centroid model. This test achieves 98.9% accuracy.

When segments are recognized as code segments, embodiments of the invention utilize methodology by Kolter and Maloof, “Learning to Detect and Classify Malicious Executables in the Wild,” which is hereby incorporated by reference herein, to identify the type of architecture associated with the code segment. Kolter and Maloof apply data mining techniques to malware detection and classification. They collect 4-grams from executables, rank them by information gain, then select the top 500 as classifier attributes. Kolter and Maloof classify the resulting 4-gram set with seven algorithms. Their best results come from the boosted decision tree and SVM algorithms. Embodiments of the invention utilize the decision tree and SVM algorithms, with Kolter and Maloof's attribute selection technique, for code architecture identification.

More specifically, Kolter and Maloof construct a system which classifies Windows executables as malicious or benign using a variety of machine learning techniques. They experiment with boosted and un-boosted decision trees, support vector machines (SVM), instance-based learners, and naive Bayes classifiers to determine the most effective technique for the classification problem. Kolter and Maloof perform pilot studies to determine the number of attributes, n-gram size, and number of bytes-per-gram that produce the most accurate results. They settle on 500 byte value 4-grams, and use these parameters for the remainder of their tests.

The researchers use information gain (IG) to determine which 4-grams best-characterize their corpus. IG provides a measure of the relevance of each 4-gram to the classification problem. IG yields larger values for features which appear more frequently in one class than another. Equation 5 provides a version of IG equivalent to Kolter and Maloof's. In it, g is a particular attribute (a 4-gram in this case) and Cᵢ is the ith class (malicious or benign). P(g) is the proportion of training samples containing attribute g, P(Cᵢ) is the proportion of training samples in class i, and P(g, Cᵢ) is the proportion of training samples of class i that exhibit attribute g (that contain the 4-gram g represents). Equation 5 then uses the presence or absence of a 4-gram to determine how well it contributes to the classification problem, and is also known as average mutual information.

$$IG ( g ) = {\sum }_{{C}_{i}} [ P ( g , {C}_{i} ) log ( \frac{P ( g , {C}_{i} )}{P ( g ) P ( {C}_{i} )} ) + ( 1 - P ( g , {C}_{i} ) ) log ( \frac{1 - P ( g , {C}_{i} )}{( 1 - P ( g ) ) P ( {C}_{i} )} ) ] \qquad ( 5 )$$

Kolter and Maloof use machine learning techniques implemented in Weka. Specifically, they use the J48, sequential minimal optimization, and AdaBoost.M1 algorithms for decision trees, SVMs and boosting, respectively. The J48 algorithm builds a binary tree with one 4-gram at each node, and branches representing presence or absence of that gram. J48 uses gain ratio, a measure similar to IG, to place each gram, then prunes unhelpful branches to avoid overtraining. The Weka SVMs implementation solves multi-class problems through pairwise classification. The AdaBoost algorithm boosts existing Weka classifiers by generating multiple classifier models, then weighting them based on performance.

Kolter and Maloof apply their classification system to a corpus of 1,971 benign and 1,651 malicious Windows executables. They find that the boosted decision tree and SVM classifiers perform best, with true positive rates exceeding 0.95 for false positive rates less than 0.05.

Each classifier used in the embodiments discussed above builds models to describe the training set. During testing these classifiers compare test samples to the models to determine which model best-matches the sample. The internal representation of the model differs by classifier, but each model must represent properties inherent to the files it represents. The classifier models are built from the training corpus defined in the table in FIG. 7.

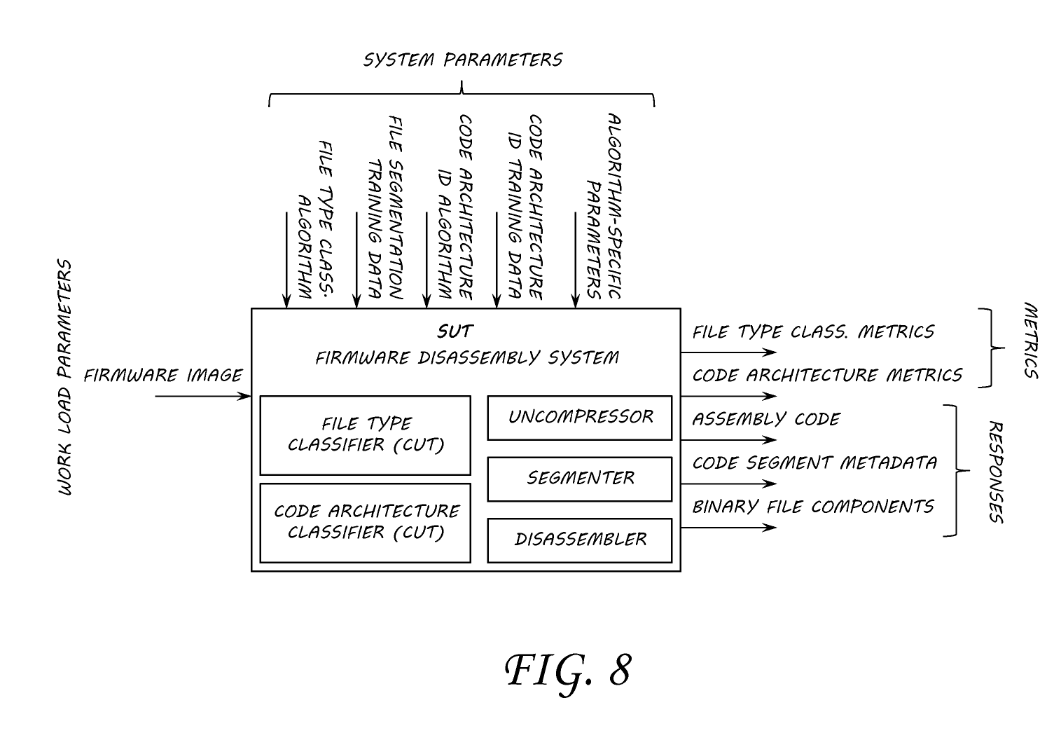

FIG. 8 illustrates a system under test as a set of inputs, outputs and components. Each component corresponds with a block in FIG. 3. The Uncompressor and Disassembler components (block 64 in FIG. 3) use standard compression and disassembly techniques. Embodiments of the invention assume that firmware uses standard compression techniques like Gzip, ZLib, and Lempel-Ziv-Markov chain algorithm (LZMA). This assumption greatly simplifies uncompression, and in practice, vendors generally use standard compression techniques. This assumption rules out proper analysis of firmwares compressed with non-standard techniques, but the system's modularity allows implementation of alternative compressions in other embodiments. The disassembler also uses existing disassembly algorithms, specifically, those implemented in the GNU Binutils project. These system components already have proven performance, and the goal of embodiments of the invention is to accurately provide those components with appropriate input, not to evaluate the accuracy of those components.

Binary firmware images are the Firmware Disassembly System's workload. Ideally, real firmwares would form the system's test set. To evaluate the system's results, however, the test set must include metadata that describes the firmware contents. Few PLC firmwares exist which meet that requirement. Therefore, for validation, the embodiments of the invention test pseudo-firmwares with known contents. Workload parameters characterize the pseudo-firmwares.

Real firmware images vary widely in composition. Simple PLCs may only require a firmware with one code segment. More complex PLCs with Ethernet interfaces may provide Web and FTP servers, and require larger firmwares that include file systems and multiple code segments. Many PLCs are modular and contain several processors with potentially different architectures.

After finding a likely match for a code section's architecture, the system disassembles that section (block 64 in FIG. 3). Disassembly must start at the correct byte offset, and in the firmware image byte offsets are arbitrary. Embodiments of the system do not automatically detect code offsets, but instead disassembles code sections at all likely offsets for an identified architecture. For each of the architectures considered, the system tries offsets of zero, one, two, and three bytes.

In practice, each disassembly produces a different set of partially-valid code, and the correct disassembly is not obvious. An analyst must manually consider each disassembly and determine which is correct. Opcode frequency analysis is one method for assisting in the process. The system automates this process by determining the frequency of all opcodes in each disassembly. It then orders the opcodes by frequency, and compares the list to one from other binaries of that architecture. It annotates the ordered list by marking those opcodes that comprise 90% of other binaries. Those opcodes generally appear more frequently in correct disassemblies than in incorrect disassemblies.

Firmware for validation of the embodiments of the invention is modeled as a concatenation of multiple files of different types. With this model, three parameters characterize a pseudo-firmware. File segment type and bounds identify the file type of a set of bytes within a firmware image, and code architecture identifies the architecture of segments with the code file type. Analysis shows that real firmwares frequently include byte-padding for some segments, but the modeled firmware does not pad pseudo-firmware segments. In practice, an embodiment including simple padding-detection heuristic would increase system performance.

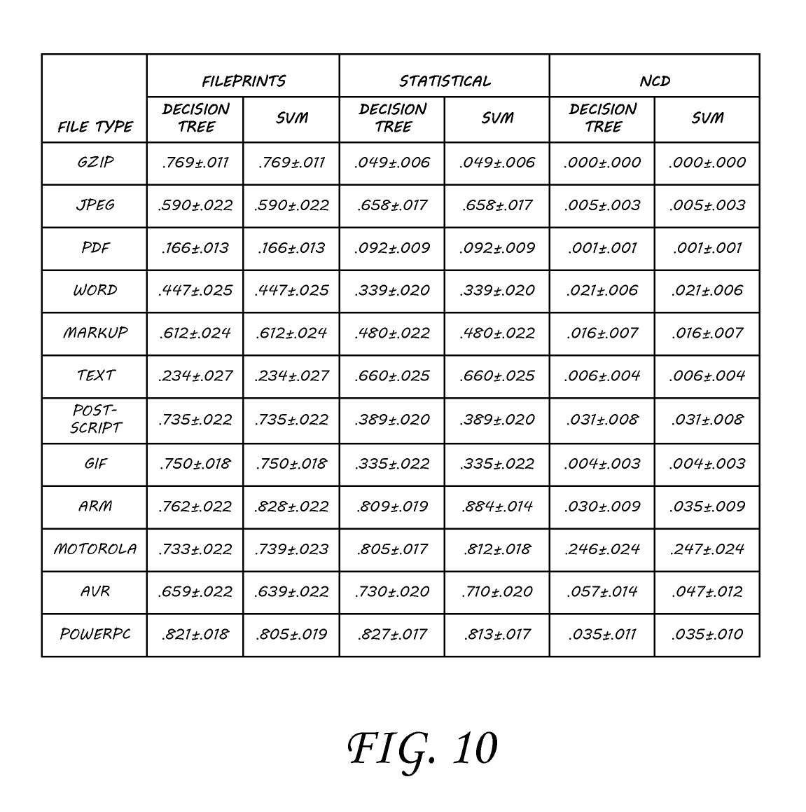

The combined accuracy of the binary image segmenter, file type classifier, and code architecture classifier is presented below. These form blocks 58, 60, and 62 in FIG. 3. The table in FIG. 9 summarizes the accuracy of the system's entire machine learning pipeline. Data points in the table provide the accuracy result of a specific file type classifier and code architecture classifier. During verification of the embodiments, a set of 3,000 pseudo-firmwares were classified with the Fileprints and statistical classifiers, and 1,000 pseudo-firmwares with the NCD classifier. In all cases, the 95% confidence interval has a width smaller than 3.2 percentage points. The combination of Fileprints and SVM, as segment type and code type classifiers respectively, produces the best overall accuracy.

During firmware analysis, however, analysts are likely to value correct identification of code segments higher than correct identification of other segments. The combination of the statistical and SVM classifiers produces the best code identification accuracy.

A consumer accuracy of the code segment classifications is also likely to concern analysts. One might focus analysis only on firmware sections classified as code segments, and in that case, higher consumer accuracy provides less data for the analyst to sift through. For the Fileprints/SVM combination, the consumer accuracy of the code file types pooled is 86.7%. For the statistical/SVM combination the same consumer accuracy value is 66.2%. The values are significantly different because the statistical classifier incorrectly identifies 4.2% of non-code data as code, while the Fileprints classifier only did so for 0.8%.

The Fileprints/SVM combination was selected for embodiments for firmware reverse engineering because of the superior code segment consumer accuracy and overall producer accuracy. The statistical/SVM classifier combination realizes a better code segment producer accuracy, but the difference is small compared to the advantage of Fileprints/SVM.

The table in FIG. 10 details the system producer accuracies. In all cases, the 95% confidence interval is smaller than 5.4 percentage points. For non-code file types, results are the same regardless of code classifier because the code classifier does not consider segments that the system identifies as non-code. The Fileprints/SVM combination classifies less than 9% of ARM code incorrectly, in the worst case identifying 3% of ARM code as GIF. The system classifies 6% of Motorola 68000 code as Word, and 3% of PowerPC code as GIF. For all three architectures the system has no other type misclassifications greater than 2%.

Of the code file types, the Fileprints/SVM combination shows the worst performance with AVR. It classifies 11% of AVR code as Motorola, and 2% total as ARM or PowerPC. Thus, the system classifies 80% of AVR code as Code, though it gets the architecture wrong nearly 1 time out of 6. In practice, this observation suggests that the system would identify the majority of code and apply the correct architecture, giving an analyst a strong hint as to the correct architecture. The system labels 9% of AVR code as GIF, 5% as Word document, and a further 3% as PDF or GZip.

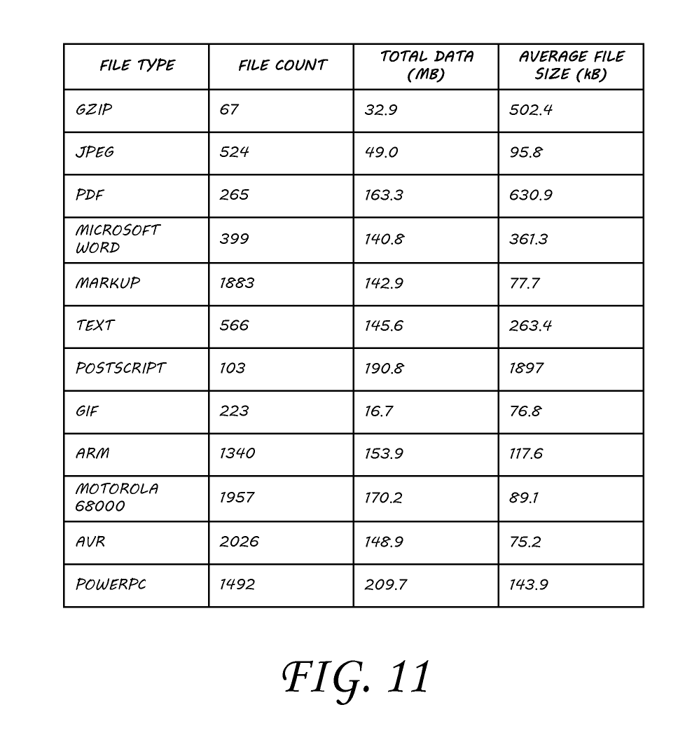

Considering consumer accuracies, 20% of data the system identifies as Motorola 68000 code is actually Word document. As illustrated in the table containing the test set characteristics in FIG. 11, the average Word document size is four times that of Motorola files, and the random firmware generator includes amounts of data proportional to file size. Consequently, the number of Word document bytes in the pseudo-firmwares used for testing is approximately four times that of Motorola 68000 bytes. Some analysis reveals that this proportion of documentation to code is uncharacteristic of real firmwares, and in this case the pseudo-firmwares do not adequately model real firmwares. The 20% value is a consequence of the poor accuracy of Fileprints on Word documents, and the disproportionate amount of Word document bytes to Motorola 68000 bytes.

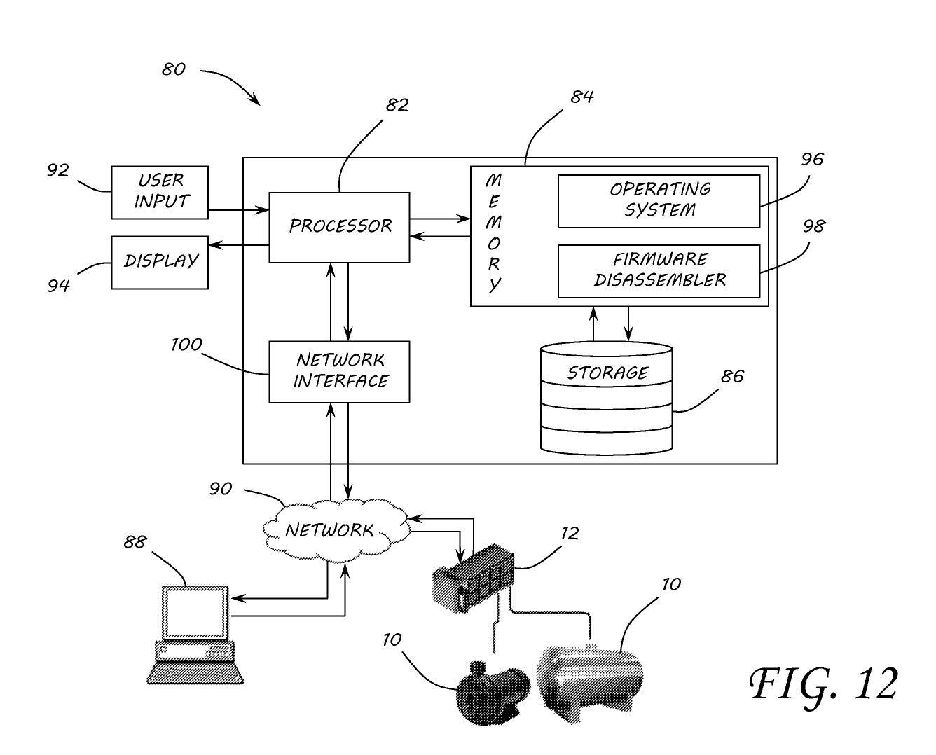

Embodiments of the invention may be implemented on numerous hardware platforms. FIG. 12 illustrates an exemplary hardware and software environment for an apparatus 80 suitable for performing firmware disassembly consistent with the invention. For the purposes of embodiments of the invention, apparatus 80 may represent practically any computer, computer system, or programmable device, e.g., multi-user or single-user computers, desktop computers, portable computers and devices, handheld devices, network devices, mobile phones, etc. Apparatus 80 will hereinafter be referred to as a “computer” although it should be appreciated that the term “apparatus” may also include other suitable programmable electronic devices.

Computer 80 typically includes at least one processor 82 coupled to a memory 84. Processor 82 may represent one or more processors (e.g. microprocessors), and memory 84 may represent the random access memory (RAM) devices comprising the main storage of computer 80, as well as any supplemental levels of memory, e.g., cache memories, non-volatile or backup memories (e.g. programmable or flash memories), read-only memories, etc. In addition, memory 84 may be considered to include memory storage physically located elsewhere in computer 80, e.g., any cache memory in a processor 82, as well as any storage capacity used as a virtual memory, e.g., as stored on a mass storage device 86 or another computer coupled to computer 88 via a network 90. The mass storage device 86 may contain a cache or other data, such as the models used to identify and classify segments of the binary firmware image as well as temporary or permanent storage of the firmware image itself.

Computer 80 also typically receives a number of inputs and outputs for communicating information externally. For interface with a user or operator, computer 80 typically includes one or more user input devices 92 (e.g., a keyboard, a mouse, a trackball, a joystick, a touchpad, a keypad, a stylus, and/or a microphone, among others). Computer 80 may also include a display 94 (e.g., a CRT monitor, an LCD display panel, and/or a speaker, among others). The interface to computer 80 may also be through an external terminal connected directly or remotely to computer 80, or through another computer 88 communicating with computer 80 via a network 90, modem, or other type of communications device. Additionally, computer 80 may receive the binary firmware image through the network 90 from a PLC 12 or RTU.

Computer 80 operates under the control of an operating system 96, and executes or otherwise relies upon various computer software applications, components, programs, objects, modules, data structures, etc. (e.g. firmware disassembler 98 having modules including uncompressing, identifying, classifying, and disassembling). Computer 80 communicates on the network 90 through a network interface 100.

In general, the routines executed to implement the embodiments of the invention, whether implemented as part of an operating system or a specific application, component, program, object, module or sequence of instructions will be referred to herein as “computer program code”, or simply “program code”. The computer program code typically comprises one or more instructions that are resident at various times in various memory and storage devices in a computer, and that, when read and executed by one or more processors in a computer, causes that computer to perform the steps necessary to execute steps or elements embodying the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of computer readable media used to actually carry out the distribution. Examples of computer readable media include but are not limited to non-transitory physical, recordable type media such as volatile and non-volatile memory devices, floppy and other removable disks, hard disk drives, optical disks (e.g., CD-ROM's, DVD's, etc.), among others; and transmission type media such as digital and analog communication links.

In addition, various program code described may be identified based upon the application or software component within which it is implemented in specific embodiments of the invention. However, it should be appreciated that any particular program nomenclature used is merely for convenience, and thus the invention should not be limited to use solely in any specific application identified and/or implied by such nomenclature. Furthermore, given the typically endless number of manners in which computer programs may be organized into routines, procedures, methods, modules, objects, and the like, as well as the various manners in which program functionality may be allocated among various software layers that are resident within a typical computer (e.g., operating systems, libraries, APIs, applications, applets, etc.), it should be appreciated that the invention is not limited to the specific organization and allocation of program functionality described herein.

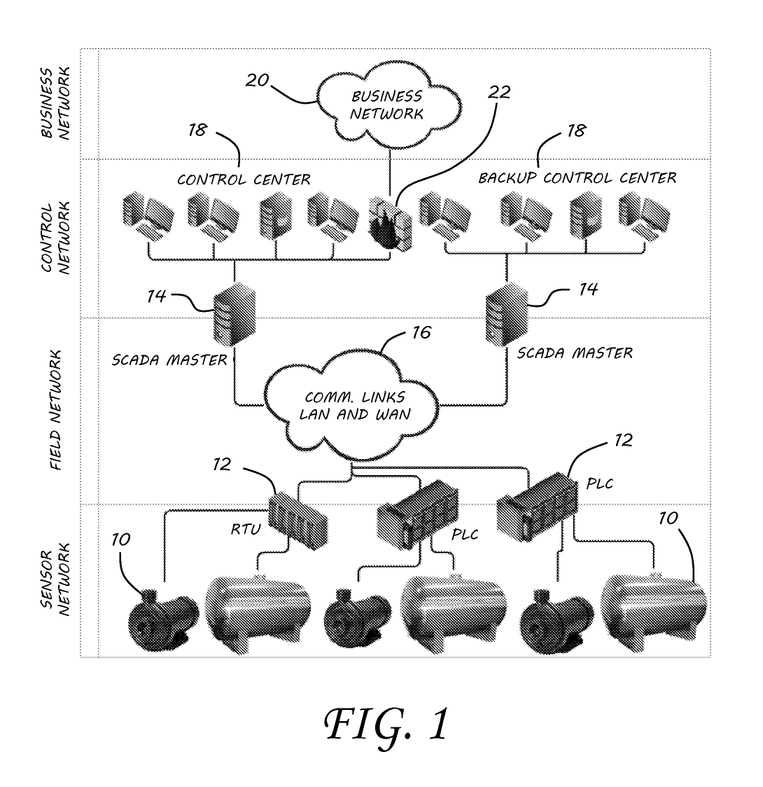

Those skilled in the art will recognize that the exemplary environment illustrated in FIG. 1 is not intended to limit the present invention. Indeed, those skilled in the art will recognize that other alternative hardware and/or software environments may be used without departing from the scope of the invention.

Embodiments of the firmware disassembly system discussed above provide analyst a tool to assist with PLC firmware disassembly. Embodiments of the system found compressed sections, determined the file type of byte ranges within the firmware, automatically disassembled likely code sections, and provided opcode frequency analysis for human reference.

While the present invention has been illustrated by a description of one or more embodiments thereof and while these embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the scope of the general inventive concept.

What is claimed is:

1. A method for disassembling firmware, the method comprising:
receiving a binary firmware image;
dividing the binary firmware image using a sliding window into a plurality of segments;
classifying segments of the plurality of segments as file types;
identifying code file types among the classified segments of the plurality of segments;
classifying code architectures of the identified code file types of the classified plurality of segments; and
disassembling at least the code file types of the binary firmware image based on the classified code architecture.

2. The method of claim 1, further comprising:
evaluating the disassembled binary firmware image for malware.

3. The method of claim 1, wherein a size of the sliding window is set such that it divides the binary firmware image into a configurable number of segments.

4. The method of claim 3, wherein a step size for the sliding window is set equal to the size of the sliding window.

5. The method of claim 1, wherein identifying code file types and classifying code architectures utilizes a group consisting of: boosted and unboosted decision trees, support vector machines, and combinations thereof.

6. The method of claim 1, wherein classifiers utilized for identifying code file types and classifying code architectures build and utilize models to determine which model best matches the segmenting being identified or classified.

7. The method of claim 1, wherein identified code file types of the binary firmware image are disassembled at all likely offsets for the classified architecture of the identified code file type.

8. The method of claim 7, wherein the likely offsets are selected from a group consisting of: zero bytes, one byte, two bytes, three bytes, and combinations thereof.

9. The method of claim 7, wherein the likely offsets are any byte value up to an instruction size of the classified architecture.

10. A method for disassembling firmware, the method comprising:
receiving a binary firmware image;
uncompressing all compressed segments within the binary firmware image;
dividing the uncompressed binary firmware image using a sliding window into a plurality of segments;
classifying segments of the plurality of segments as file types;
identifying code file types among the classified segments of the plurality of segments;
classifying code architectures of the identified code file types of the classified plurality of segments; and
disassembling at least the code file types of the binary firmware image based on the classified code architecture.

11. The method of claim 10, further comprising:
evaluating the disassembled binary firmware image for malware.

12. The method of claim 10, wherein a size of the sliding window is set such that it divides the binary firmware image into a configurable number of segments.

13. The method of claim 12, wherein a step size for the sliding window is set equal to the size of the sliding window.

14. The method of claim 10, wherein identifying code file types and classifying code architectures utilizes a group consisting of: boosted and unboosted decision trees, support vector machines, and combinations thereof.

15. The method of claim 10, wherein classifiers utilized for identifying code file types and classifying code architectures build and utilize models to determine which model best matches the segmenting being identified or classified.

16. The method of claim 10, wherein identified code file types of the binary firmware image are disassembled at all likely offsets for the classified architecture of the identified code file type.

17. The method of claim 16, wherein the likely offsets are selected from a group consisting of: zero bytes, one byte, two bytes, three bytes, and combinations thereof.

18. The method of claim 16, wherein the likely offsets are any byte value up to an instruction size of the classified architecture.

19. An apparatus, comprising:
a memory;
a processor; and
program code resident in the memory and configured to be executed by the processor configured to disassembling firmware, the program code further configured to receive a binary firmware image in the memory, divide the binary firmware image using a sliding window into a plurality of segments, classify segments of the plurality of segments as file types, identify code file types among the classified segments of the plurality of segments, classify code architectures of the identified code file types of the classified plurality of segments, and disassemble the binary firmware image based on the classified code architecture.

20. The apparatus of claim 19, wherein the program code is further configured to:
evaluate the disassembled binary firmware image for malware.

21. The method of claim 19, wherein identifying code file types and classifying code architectures utilizes a group consisting of: boosted and unboosted decision trees, support vector machines, and combinations thereof.

22. The method of claim 19, wherein identified code file types of the binary firmware image are disassembled at all likely offsets for the classified architecture of the identified code file type selected from a group consisting of: zero bytes, one byte, two bytes, three bytes, and combinations thereof.

23. The method of claim 19, wherein identified code file types of the binary firmware image are disassembled at offsets consisting of any byte value up to an instruction size of the classified architecture.
